(19) United States
(12) Patent Application Publication
(10) Pub. No.: US 2010/0114432 A1
(43) Pub. Date: May 6, 2010

(54) Method to isolate vehicle steering shock from the driver

(76) Inventor: Philip Lee Brooks, Sunnyvale, CA (US)

Correspondence Address: Phil Brooks, 747 Lakefair Drive, Sunnyvale, CA, 94089, US

(21) Appl. No.: 12/290,512

(22) Filed: Nov. 1, 2008

(51) Int. Cl. B62D 6/00

(52) U.S. Cl. 701/41

(57) ABSTRACT

The method, independent of specific means employed, of locking/un-locking the steering mechanisms of a vehicle for a time period measured in as little as milliseconds in order to isolate the driver of the vehicle from violent shocks as encountered when, for example, a vehicle strikes an obstruction with a steered wheel. Said method also includes the ability for users to pre-program, or to program from the driving position, various profiles of lock/un-lock to accommodate variations in the type of obstructions anticipated to be encountered as well as at least one default setting to take into account crash situations. The method of the present invention is independent of means so long as the result is to lock/un-lock the steering mechanism(s) for a fixed or a variable period measured in as little as milliseconds in order to isolate the driver from violent impacts to the steered Wheels/Tires of a vehicle being transmitted to the driver through the Steering Wheel. The intent of the present method is to protect the driver's hands and wrists, to require less concentration and physical exertion on the part of the driver when encountering obstacles, to allow for lighter and less power-consuming devices to assist steering, and to allow the vehicle to more closely maintain the path intended by the driver.

### CROSS REFERENCE TO RELATED APPLICATIONS

None

### FEDERALLY SPONSORED RESEARCH

Not Applicable.

### SEQUENCE LISTING OR PROGRAM

Not Applicable.

### BACKGROUND OF THE INVENTION

1. Field of the Invention.

### BACKGROUND OF THE INVENTION

This invention generally relates to a method to virtually eliminate the shock transmitted from a vehicle's steered Wheel/Tire through the steering apparatus and subsequently (immediately) to be felt by the driver as a sharp kick-back in the Steering Wheel when, for example, a steered Wheel/Tire strikes a Curb. The clearest and simplest illustrative example is a racing vehicle intentionally steered up and over Curbs placed at the edge of a racing surface to discourage the driver from using the surface next to the intended racing surface to gain a competitive advantage.

2. Prior Art

Previous steering shock attenuators (shock-absorbers) employed for the purpose of reducing the shock transmitted from a vehicle's steered Wheel/Tire through suspension system. While other various shock absorption or damping may be employed in the steering apparatus (for example by means of power steering), they all still allow said shock to felt by the driver as a sharp kick-back in the Steering Wheel. All of the present shock absorption means act very slowly relative to the speed of the vehicle striking a Curb. Accordingly, the resultant sharpness of the impact is transmitted to the driver because the existing present attenuating (shock-absorbing) does not occur quickly nor “powerful” enough (a significant amount of shock is still transmitted through to the driver) to protect the driver. Such shock-absorbers are typically hydraulic/gas or friction and are “always on”—meaning that even relatively slow movements of the steering mechanism add to the force required to steer the vehicle. This means that there is always some incremental added force required by the driver to steer except when going in a straight or nearly straight line, or when making (relatively) long sweeping arcs with the vehicle. This force is either provided by the driver's muscles (which fatigues the driver) or by the power steering apparatus (which wastes engine power).

The driver (even through the power steering) must therefore exert exacting counter-force on the Steering Wheel in order to make the vehicle stay on the course intended by the driver or nearly so. In all such high impact cases, the driver must correct (counter) the motion (the reaction) of the wheels/vehicle which, as a result of the high-speed impact, has been moved “off the intended course” in reaction to the sharp impact with the Curb, object, or hole. This action/reaction scenario bleeds-off speed and also causes the vehicle to try to follow a less optimal course—and is therefore undesirable in a competitive situation and often poses a safety threat as well.

3. Objects and Advantages

Accordingly, several objects and advantages of the invention are in serving the following unmet needs:

A first wholly un-served need exists for a steering shock-absorption/shock isolation method that would react in a few milliseconds to effectively isolate the Steering Wheel (the driver) from the impacts described above and absorb virtually all of the action/reaction forces generated when striking a Curb, object, or hole at high speed. Such isolation would reduce the fatigue of the drivers and allow them to concentrate on increasing speed rather than mitigating the loss of speed as well as allow possible reductions in the power drain of the power steering by using a smaller or less powerful unit.

With regard to the intended direction of the vehicle, all present solutions require the driver to re-aim the vehicle after a high-speed action/reaction as described above. This means that the driver presently must, to some degree, over-steer the car (exaggerate the input to the steering apparatus) in anticipation of the opposite dynamic reaction of the vehicle to the shock encountered and then and secondly, re-aim the vehicle after it lands back on the racing surface after being launched into the air (or nearly into the air) by the Curb. For illustrative example, if the driver intends to turn to the right and cut the corner apex short (a straighter and shorter path resulting in less time-used and less speed being scrubbed-off) by going up and over the Curb, and the Curb is accordingly on the driver's right-hand side, the action of striking the Curb will throw the vehicle to the left to a significant degree while at the same time the steering apparatus is being forced into “turning left” by the force of the impact—especially considering that the vehicle may well be airborne at the time the reaction is fully absorbed by the vehicle itself. Therefore, the driver must turn even more sharply to the right (scrubbing off more speed) to account for the anticipated resultant higher left-forcing reaction.

However, turning the Wheel/Tire to the right even a small amount more than absolutely necessary to negotiate the intended path actually increases the geometric profile of impact of the steered Wheel/Tire causing an even more exaggerated action/reaction. This is explained by describing that the Wheel/Tire presents a more flat surface (the surface across the tire) to the face of the Curb which results in striking the Curb with a significantly “less glancing” blow and in fact a more “head-on” blow to the Curb/Wheel/Tire. All of the above scrub-off speed and require even more time to negotiate the intended path.

Therefore, a second un-served need exists for a steering shock-absorption/shock isolation method that will react to the impact fast enough to “freeze the steering apparatus” for a few milliseconds such that the Wheel/Tire is not allowed to present said increasingly flat surface to the face of the Curb which typically results in “more air time” with attendant increased movement opposite of the driver's intention owing to the lack of tire contact with the racing surface.

Further, a third un-served need exists for a steering shock-absorption/shock isolation method that will react to the impact fast enough to “freeze the steering apparatus” for a few milliseconds such that the Wheel/Tire does not present an increasingly flat surface to the face of the Curb (when the Wheel/Tire strikes the Curb, the Wheel/Tire is forced to turn into the Curb while the driver wishes to go in the direction originally directed by the Steering Wheel) and which is not “always on” (as described above, with attendant loss of power from the engine and additional physical effort from the driver) but rather instant-on, instant-off.

A fourth un-met need is for isolating the driver from un-anticipated (and un-intended) high-speed shocks to the steering apparatus when not negotiating a turn (although the un-anticipated shock could of course occur during a turn). The clearest and simplest illustrative examples are objects (obstructions) so suddenly presenting themselves to the driver that avoidance is not possible: or a hole in the surface which for any of a multiplicity of reasons, is not seen (or seen in time) by the driver. Further illustrative examples are when a obstruction presents itself to the driver in a situation over which the drive has no control (such as a slippery surface, loss of brakes, or having been knocked off-course by a competitor). The same method applies—that is to say that the steering apparatus is momentarily “frozen” such that the Steering Wheel is not violently jerked to one side or the other upon impact.

A fifth un-met need but related to the above, is for isolating the driver from the extreme dynamic force of a crash situation (wherein racing drivers are currently and wisely trained to let go of the Steering Wheel completely to avoid breaking their wrists and hands). In this extreme example, the need may well be for a freeze period longer than a period typically measured in milliseconds.

### SUMMARY

It follows then that the un-met needs above and many other “ordinary driving” needs can most advantageously be met by a method that can actually “freeze” the steering apparatus for a period of milliseconds and not simply “reduce the shock”. Further, said method must be “instant-on” and “instant-off” or the driver will not thereafter be able to steer the vehicle owing to the steering being effectively locked.

The period of milliseconds employed will depend wholly on the vehicle, the vehicle's speed, the users intentions when determining the use(s) of the method, and the anticipated objects (obstructions) being addressed.

Existing solutions embody a reduction of force transmitted to the driver, but no existing solution virtually isolates the driver from those forces.

All present solutions for “isolating the driver” from Steering Wheel shock and reactive movement are seriously handicapped by exhibiting one or more of the following serious limitations:
i. The driver is not effectively isolated from the shock and reactive movement causing un-necessary skeletal strain in the driver's hands, wrists, and neck—even to the point of breaking.
ii. Great muscular effort is required by the driver to not allow the Steering Wheel to be wrested from his grasp in high-shock situations.
iii. The effort in i and ii above dissipates the effective energy and focus of the driver.
iv. The driver's concentration is disrupted by un-necessary over-compensation mental calculations.
v. The optimal course of direction of the vehicle is seriously compromised.
vi. The driver must preemptively over-compensate for the anticipated action/reaction with attendant opportunity for mis-calculations.
vii. The vehicle's contact (grip) with the road or course surface is reduced owning to the vehicle being caused to be airborne or nearly airborne longer than necessary (such as presenting a more increasingly flat steered Wheel/Tire surface to the object encountered).
viii. Striking an un-anticipated object in the path of the vehicle may cause the Steering Wheel to be completely and violently wrested from the driver's hands—especially in a crash situation.
ix. Reacting slowly enough so that in the illustrative example of a hole in the pathway being struck, the vehicle may be caused to spin, strike other objects, or roll-over owing to the un-dampened forces.
x. Even when present steering damping systems are reacting relatively slowly, there is a latent drag on the power of the vehicle owing to the fact that the (power) steering must be active at all times comprising a constantly available latent power sufficient to dampen (but not isolate) the shock to a steered Wheel/Tire being transmitted to the driver.

### DRAWINGS—FIGURES

FIG. 1: Recognizing the relative shock absorber compression when Wheel/Tire is on level surface

FIG. 2: Recognizing the relative shock absorber compression when Wheel/Tire strikes Curb

FIG. 3: Showing the Steering Master Actuator un-compressed and the driver free to steer the vehicle

FIG. 4: Showing the violent action against the Steering Wheel when the vehicle hits a Curb rendering the driver momentarily unable to steer the vehicle in the most efficient manner

FIG. 5: Showing the Steering Master Actuator compressed and the driver isolated from the shock

FIG. 6: Showing a few illustrative examples of alternative means of actuation of the Steering isolation Millisecond Lock other than by hydraulic/pneumatic/purely mechanical means

### DESCRIPTION OF THE INVENTION

The easiest and most convenient illustrative example of the present invention is to consider the vehicle in which the method invention has been applied-to as being a racing car. These cars are routinely and intentionally driven over Curbs placed at the edge of a racing surface to discourage the driver from using the surface next to the intended racing surface to gain a speed/time advantage. Accordingly, the action/reaction scenario is, for the purposes of describing the method of present invention, straight-forward in operation and operational environment when racing cars are presented as the illustrative example.

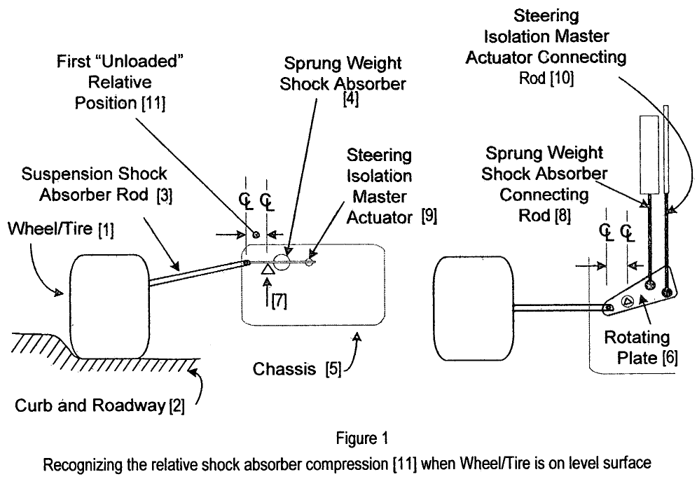

The process of the method of the present invention is to simply add-on to the existing (current generalized/stylized racing car practice) shock absorbing linkages. (Referring to FIG. 1): the vehicle is shown in a First “Un-Loaded” Relative Position [11]. The steered Wheel/Tire combination [1] is shown in contact with the flat portion of the Curb and Roadway [2] and is (the steered Wheel/Tire) linked to a first Suspension Shock Absorber Rod [3], and to the Sprung Weight Shock Absorber [4] which is engaged with the Chassis [5] by means of a Rotating Plate [6] with a Fulcrum Point [7] approximately as shown. Said Rotating Plate is the attachment means for the Sprung Weight Shock Absorber Connecting Rod [8] which acts as the plunger for the Sprung Weight Shock Absorber [4]. Said Rotating Plate [6] is, in the present illustrative present example, also the attachment means for the Steering Isolation Master Actuator [9] and the Steering Isolation Master Actuator Connecting Rod [10]. The operation of [3], [4], [6], [8], [9] and [10] with [7] being the approximate rotation point, acting together as the input means portion of the method of the present invention will be described later.

FIG. 1 then, shows the approximate relationship of the various apparatuses in the First “Unloaded” Relative Position [11] (normal position when the vehicle is resting on its wheels) whether at speed or stopped (except for the consideration of added downforce caused by aerodynamic features or of cornering or braking forces when the vehicle is at speed), shown as the relative distance between the two CenterLine notations.

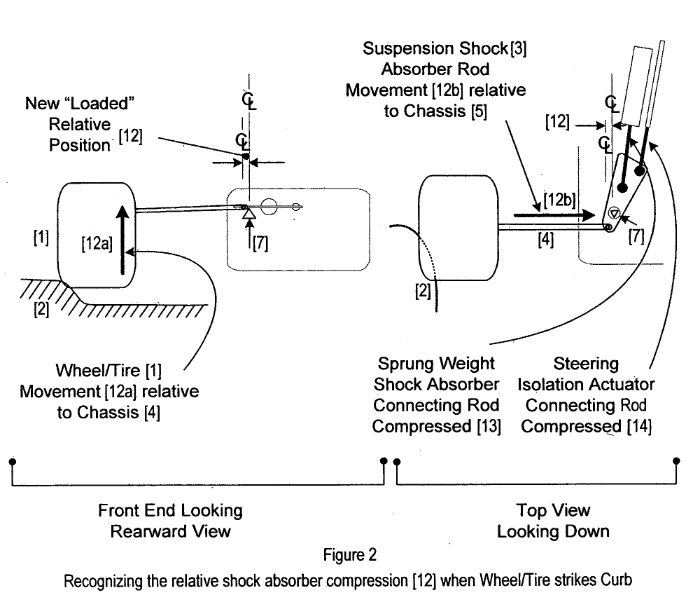

Referring to FIG. 2, the vehicle is shown in the Second “Loaded” Relative Position [12] (in this illustrative example, the reaction of the suspension apparatus to striking a Curb) shown as the relative distance between the two CenterLine notations as being smaller than the situation in the First “Unloaded” Relative Position [11]. The Movement [12a] of the Wheel/Tire [1] and the first Suspension Shock Absorber Rod [3] acting as the force to move the Rotating Plate [6] serves to compress the Sprung Weight Shock Absorber Connecting Rod [8] and to compress the Steering Isolation Master Actuator Rod [10] at a much faster rate than [8]. The action of these Rods in this particular illustrative example is best described as that of a plunger and is more fully described later.

It directly follows then, that since the relative physical position of the Rods [8] and [10] when Plate [6] rotates (as shown in FIG. 2) causes a faster/further movement of the Steering Isolation Master Actuator Rod [10] into the Actuator [9] than the Sprung Weight Shock Absorber Rod [8] into the Sprung Weight Shock Absorber [4], there exists an opportunity to capitalize on this faster/further motion to cause an exaggerated result of [9] over [10]. Expressed another way, [9] can generate an “on-off” signal/action much earlier and much faster than [4]. Accordingly, the signal/action of [9] can be used to cause, by employment of the present invention method, to momentarily freeze/un-freeze (lock/un-lock) the steering mechanism without affecting in any way the intended utility of [3].

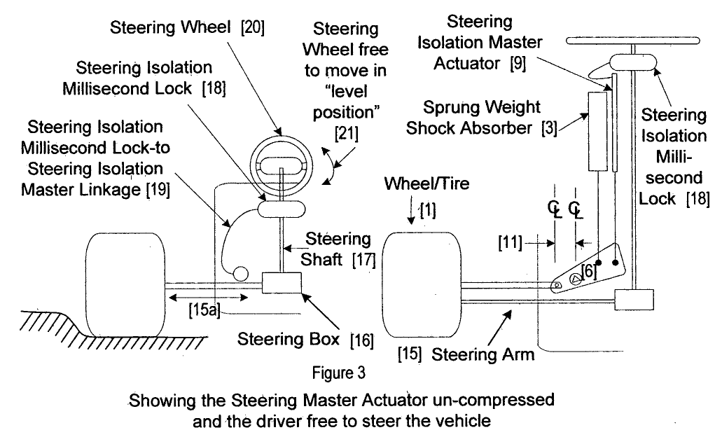

Accordingly, in FIG. 3 the suspension system is shown in the First “Un-loaded” Relative Position (un-compressed) [11]. With the method of the present invention, there is no latent effect on the vehicle's steering (and resultant power-drag on the engine nor physically exhaustive effect on the driver). In other words, the method of the present invention is “off” unless there is a dramatic shock to the Steering System. This is because the Steering Isolation Master Actuator, whatever its make-up or configuration, is designed to react to relatively sudden shock (as in striking an object), not react to gradually increasing loads on the suspension/steering mechanisms, nor input from the driver.

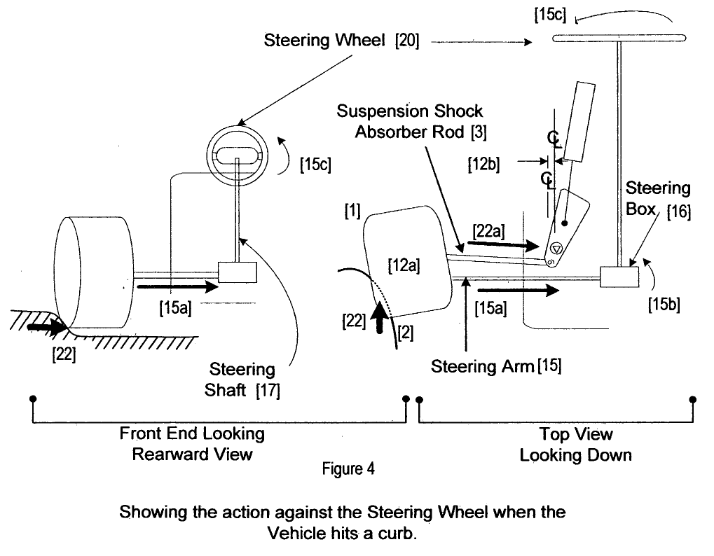

In FIG. 4, it follows then the suspension system is shown in the Second “Loaded” Relative Position (compressed) [12]. As the Wheel/Tire [1] strikes an obstruction (in this illustrative example a Curb [2]), the impact [22] of striking the Curb [2] has the effect of trying to turn the steered Wheel/Tire [1] very sharply into the Curb [2]. Said impact force [22] causes the steered Wheel/Tire [1] to be forced inward [15a] and upward [12a] very rapidly. Said rapid movement of the Suspension Shock Absorber Rod [3] causes movement [22a], and hence the Plate [6] to rotate on its Fulcrum Point [7], allowing the relative compression shown as [12b]. The movement of the Steering Arm [15a] causes rotation inside the Steering Box [15b] thus rotating the Steering Shaft [17] and the Steering Wheel [20].

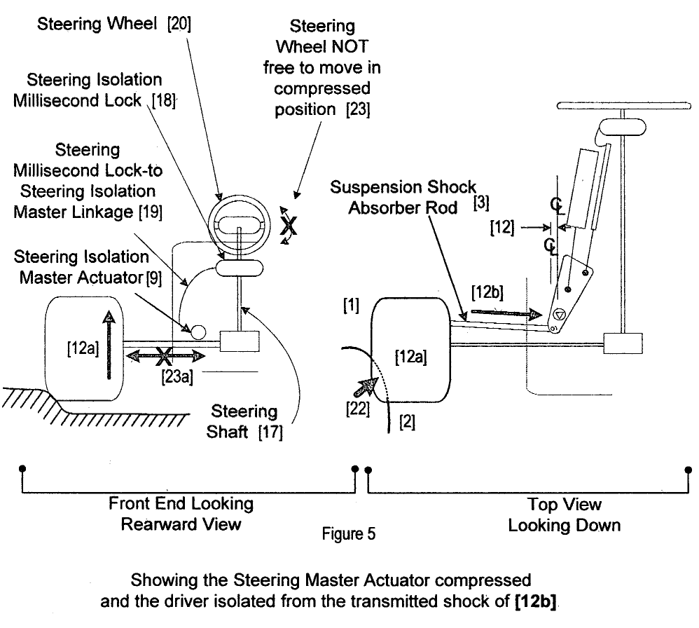

In FIG. 5 the suspension system is also shown in the Second “Loaded” Relative Position (compressed) [12]. As the steered Wheel/Tire [1] strikes an obstruction (in this illustrative example a Curb [2]), the impact [22] of striking the Curb [2] has the effect of forcing the steered Wheel/Tire [1] upward [12a] very sharply and very rapidly, which has the effect of setting-off (initiating) the method of the present invention, allowing said method to react to the rapid movement of the Suspension Shock Absorber Rod [12b]—and so it follows that the Steering Isolation Master Actuator [9], whatever its configuration or construction, trips the Steering Millisecond Lock [18] which must, for a period of milliseconds, stop the Steering Rod [15] from causing the Steering Box [16] to rotate the Steering Shaft [17] and the Steering Wheel [20] and to freeze the steering mechanism such that the Steering Wheel [20] cannot rotate [23], and the Steering Rod [15] cannot move as shown by [23a].

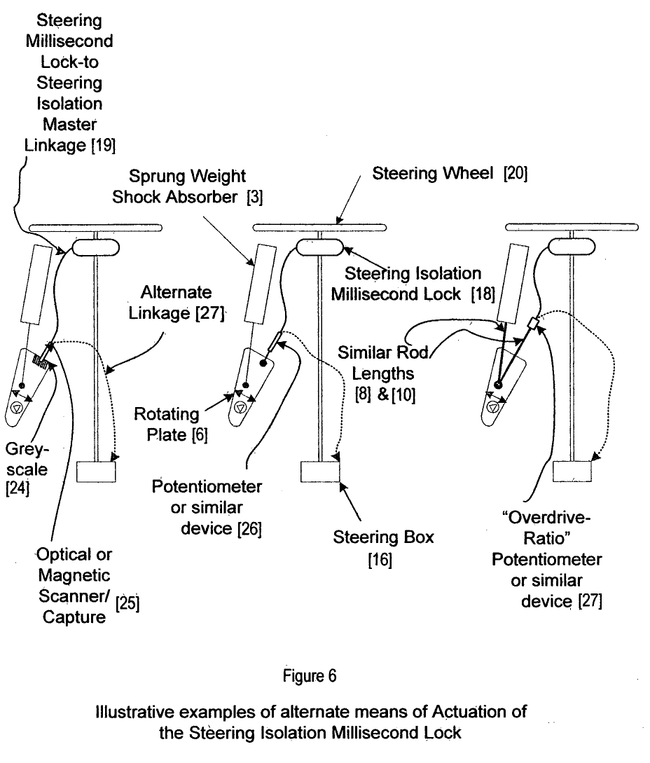

FIG. 6 illustrates merely a few examples of means to employ to execute the method of the present invention. A Grey Scale indicator [24] means may be employed to trigger an Optical or Magnetic Scanner Capture means [25] as a “non-mechanical” actuating means. A Potentiometer [26] or similar device may be employed as a signal to-capture the movement of the steered Wheel/Tire. The difference in the movement of the two “plunder rods” [8] and [10] may be “virtual”—which is to say that measuring the actual movement of two similar devices may be programmed or designed such that any movement is automatically exaggerated “over-driven” and therefore realizing the method of the present invention to, in a matter of milliseconds, freeze/un-freeze the steering mechanisms.

It is important to recognize that the “Rotating Plate” is only the simplest and most straightforward illustrative example. There is no need for a Rotating Plate if the Steering Isolation Master Actuator works directly by electronic or electro-mechanical means which are “looking at” the motion of the suspension and which embody any convenient means (no matter the means employed) a quicker/faster /exaggerated recognition of the movement of the suspension apparatus.

Therefore in all embodiments of the present invention, an important aspect is that it is possible to pre-set the lock/unlock steering millisecond isolation profile for an entire specific race track or for the driver to be able to vary said lock/unlock millisecond profile corner-to-corner from a variable device in the cockpit. This allows the vehicle to respond differently to the various shock profiles anticipated to be encountered in a specific race track.

Accordingly, while a great many opportunities exist to anticipate known impact events, it is trivial to have a default setting which would be automatically enabled in the event of a wholly unanticipated serious shock event such as striking a restraining barrier, an obstruction, or another vehicle with a steered Wheel/Tire in a crash situation. This would save the wrists of the driver from being potentially severely damaged, and rather having the driver's wrists being still useable, it is possible for the driver to avoid further damage to himself, the vehicle, and/or the objects in the surrounding environment.

A further advantage of a lock/unlock steering millisecond isolation method is that during the shock event the vehicle is able to maintain a course of direction more closely matching the intent of the driver, hence saving time and speed.

Conclusion, ramifications, and Scope

Accordingly, the reader will see that by the method and means of the present invention, I have provided a versatile method, independent of any specific means, to isolate the Steering Wheel and hence the driver of a vehicle from the shock of having a steered Wheel/Tire strike an obstruction.

The variety of situations in which the method of the present invention might be employed are not restricted to racing vehicles, although the clearest and simplest illustrative examples of the utilization of the method and (any convenient) means of the present invention is illustrated by the example of a racing vehicle.

Thus the scope of the invention should be determined by the appended claims and their legal equivalents, and not by the illustrative examples given.

### NUMBERING SYSTEM

[1] Steered Wheel/Tire combination
[2] Curb and Roadway
[3] Suspension Shock Absorber Rod
[4] Sprung Weight Shock Absorber
[5] Vehicle Chassis
[6] Rotating Plate
[7] Fulcrum Reference Point
[8] Sprung Weight Shock Absorber Connecting Rod uncompressed (normal)
[9] Steering Isolation Master Actuator
[10] Steering Isolation Master Actuator Connecting Rod uncompressed (normal)
[11] “Unloaded” Relative Position of Plate and Fulcrum Reference Point
[12] “Loaded” Relative Position of Plate and Fulcrum Reference Point
[12a] Upward movement of the Wheel/Tire and related affixed components upon striking Curb
[12b] Inward movement of the Suspension Shock Absorber Rod when Wheel/Tire strikes Curb
[13] Sprung Weight Shock Absorber connecting rod compressed
[14] Steering Isolation Master Actuator Connecting rod compressed
[15] Steering Arm position going straight ahead (level position)
[15a] Steering Arm free to move in the “level position”
[16] Steering Box
[17] Steering Shaft
[18] Steering Isolation Millisecond Lock
[19] Steering Isolation Millisecond Lock-to-Steering Isolation Millisecond Master Linkage
[20] Steering Wheel
[21] Steering Wheel free to move in the “level position”
[22] Compression Force generated when the Wheel/Tire strikes Curb
[23] Steering Wheel NOT free to move in the “striking Curb position”
[23a] Steering Arm NOT free to move in the “striking Curb position”
[24] Grey-Scale Optical Trigger
[25] Optical Capture Device
[26] Potentiometer or similar device
[27] “Over-Drive Ratio” or similar “difference-of-movement” sensing device

1. A vehicle steering millisecond isolation (lock) system method comprising:
a) at least one impact sensing device that senses impact upon a vehicle's suspension and which is independent from the vehicle's main suspension shock absorption system
b) a means of transmitting said impact signal (force) to a steering mechanism locking device
c) said signal (force) transmission being much quicker than the vehicle's main suspension system shock absorption system reacting to the same impact
d) said sensing device, upon sensing impact, then triggering a millisecond steering locking device
e) said millisecond steering locking device serving to isolate the vehicle's Steering Wheel from said shock the functional ability of said steering millisecond isolation system to release (un-lock) said vehicle's steering mechanism after a predetermined number of milliseconds

2. The system of claim 1 comprising the functional ability of unlocking itself after a variable period of milliseconds pre-determined by the user.

3. The system of claim 1 comprising a plurality of sensors each of which would embody the ability to react differently to different profiles of shock.

4. The system of claim 1 comprised of sensors which are hydraulic or pneumatic.

5. The system of claim 1 comprised of sensors which are motion sensing electronically, optically, or mechanically.

6. The system of claim 1 comprised of sensors or mechanisms which are ratio-dependent and being mechanical, electro-mechanical, or electronic.

7. The system of claim 1 comprised of sensors which are comprised of a combination of the above means.

8. The system of claim 1 in which the signal transmission from the motion sensing means to the Steering Isolation Millisecond Lock means is electronic or electrical.

9. The system of claim 1 in which the signal (force) transmission means is mechanical.

10. The system of claim 1 in which the signal (force) transmission means is electro-mechanical.

11. The system of claim 1 in which the signal (force) transmission means is a combination of the above.

12. The system of claim 1 in which the Steering Isolation Locking means is electro-mechanical

13. The system of claim 1 in which the Steering Isolation Locking means is mechanical.

14. The system of claim 1 in which the Steering Isolation Locking means are hydraulic or pneumatic.

15. The system of claim 1 in which the Steering Isolation Locking means are a combination of the above means.
